(19) United States
(12) Patent Application Publication
(10) Pub. No.: US 2024/0124042 A1
(43) Pub. Date: Apr. 18, 2024

(54) TENSION-TRANSMITTING DEVICE FOR A CHILD TRAILER

(71) Applicant: CYBEX GmbH, Bayreuth (DE)

(72) Inventors: Johannes ZURWESTEN, Bayreuth (DE); Andreas SCHERGUN, Bayreuth (DE)

(21) Appl. No.: 18/546,399

(22) PCT Filed: Feb. 15, 2022
(86) PCT No.: PCT/EP2022/053587

§ 371 Date: Aug. 14, 2023

(30) Foreign Application Priority Data
Feb. 15, 2021 (DE) 20 2021 100 741.9

(51) Int. Cl. B62B 5/06; B62K 27/00

(52) U.S. Cl. CPC B62B 5/068; B62K 27/003

(57) ABSTRACT

A traction transmission device including a traction bar for transmitting a traction force of a traction device, such as a traction harness for a running person or a trailer coupling of a vehicle, to a child trailer, comprising a first portion having a first end and a second end, a second section having a first end and a second end, wherein one of the first ends is connected or connectable to the child trailer and another of the first ends is connected or connectable to the traction device, wherein the second ends are connected via a connecting means, such as a joint, in such a way that a relative movement, such as a relative pivoting movement, is enabled between the second ends in a state of use of the traction transmission device.

The invention relates to a traction transmission device, in particular a traction bar, for transmitting a traction force of a traction device, in particular comprising a traction harness for a running person or a trailer coupling of a vehicle, to a child trailer, as well as a system comprising such a traction transmission device.

Traction transmission devices (in particular traction bars) for transmitting a tractive force of a traction device, e.g. a traction harness for a running person, to a child trailer are known in principle.

In general, according to the state of the art, cargo trailers (especially child trailers that have a receiving device for receiving at least one child) can be pulled by people directly (for example, via a harness, e.g. a belt system) or indirectly (for example, via a bicycle or other vehicle). Such cargo trailers (child trailers) are often attached to the harness or bicycle by means of a traction bar or a drawbar in order to enable the transmission of pulling forces and a constant distance of the (pulling) person to the trailer.

If the person pulling the trailer starts to move in order to pull the trailer, the corresponding movements are normally transmitted to the child trailer without being damped and can cause unwanted, disturbing or even dangerous vibrations for the child. In particular, uneven movements of the person pulling, especially the hip of the person pulling, in the direction of movement or in a vertical direction can be problematic. On the other hand, it can also happen that the child trailer transmits (undesired) movements or vibrations to the person pulling the child, which can hinder the person pulling the child, especially their walking movements.

In order to at least reduce such a problem, the state of the art describes damping these movements or, respectively, their transmission.

U.S. Pat. No. 8,091,899 B2 shows a traction transmission device (or, respectively, traction bar) which is connected or can be connected to a traction harness for the person pulling via a (flexible) connecting means. The flexible connecting means is specifically designed as a flexible line. This flexible line is surrounded by rigid links that are movable in relation to each other. The connecting means extends over a comparatively wide area and therefore requires a comparatively large installation space. Furthermore, a large number of links that can move against each other is necessary, which is comparatively expensive and can lead to a susceptibility to errors.

U.S. Pat. No. 9,840,266 B2 discloses a curved traction bar that is flexibly designed to dampen vibrations generated. For this reason, U.S. Pat. No. 9,840,266 B2 is limited with regard to the choice of material. The material required is usually comparatively expensive or also complex to process. In case of a defect, the traction bar must be (at least almost) completely replaced. Furthermore, U.S. Pat. No. 9,840,266 B2 also shows a connecting means in which the traction bar can have a damping element in relation to the holding harness. The problem with this damping element is that damage can occur, in particular due to the unlimited load, which can result in an (unintentional) destruction of the connection between the harness and the traction bar.

From U.S. Pat. No. 9,434,401 B2 it is known to mount a leaf spring as a damping element between a tension arm and a belt system. Here again, there is the problem that (under high loads) a break can occur and thus an unintentional destruction of the connection between the belt system and the tension arm.

WO 2018/148826 A1 discloses a traction bar that can be folded in on itself. In a state of use, a joint is fixed for folding, so that in the state of use no relative pivoting is possible between the two portions that can be folded against each other. Also here (only) a leaf spring within a connection between the traction device and the belt system is shown (similar to U.S. Pat. No. 9,434,401 B2).

It is an object of the invention to propose a traction transmission device, whereby movements (in particular vibrations) can be absorbed or reduced in as simple (in particular compact) and safe a manner as possible. In particular, movements between the person pulling and the child trailer should be decoupled as simply and effectively (and yet safely) as possible.

This object is solved in particular by the features of claim 1.

In particular, the object is solved by a traction transmission device, preferably a traction bar, for transmitting a traction force of a traction device, preferably comprising a traction harness for a running person or a trailer coupling of a vehicle (or the vehicle itself, optionally including the trailer coupling), to a cargo trailer (preferably a child trailer), comprising a first portion having a first end and a second end, a second portion having a first end and a second end, one of the first ends (of the first and second portions) being connected or connectable to the cargo trailer (child trailer) and another (or the other) of the first ends (of the first and second portions) being connected or connectable to the cargo trailer (child trailer) and the other of the first ends (of the first and second portions) being connected or connectable to the traction device, wherein the second ends (of the first and second portions) are connected via a connecting means, preferably comprising a joint, in such a manner that a relative movement, preferably a relative pivotal movement, is allowed between the second ends (of the first and second portions) in a state of use of the traction transmission device.

A first (independent) aspect of the invention is in particular to divide a traction transmission device (traction bar) into two portions in such a way that these are also movable relative to each other in a state of use. By a state of use is meant in particular a state in which the traction transmission device is used in such a way that the cargo trailer (or, respectively, child trailer) can be pulled by the traction device (in a controlled manner). In this sense, a state such as that described in WO 2018/148826 A1, for example, in which the joint described there is not locked, would not be a state of use (since the traction transmission device or, respectively, traction bar shown there could then not be used in a meaningful way).

By dividing the traction transmission device (traction bar) into two portions in this way, it is possible to easily compensate for and/or dampen relative movements between the traction device (or person pulling) and the child trailer. In particular, a comparatively reliable and compact design can be achieved.

A general idea of the invention thus lies in the subdivision of the traction transmission device into the at least two portions (namely the first and the second portion), the two portions in turn being movable relative to one another (in particular also or only in the state of use), in particular being pivotable relative to one another.

A connecting means is in particular a device that holds the parts to be connected together. In particular, the (respective, in particular also the first and second) connecting means explained below should be able to hold the respective parts (portions) together independently (i.e. even if, for example, in the case of a first connecting means, a further connecting means, such as a second connecting means, are thought as being absent or, respectively, are omitted).

Preferably, a damping device is associated with the connecting means in order to dampen the relative movement, in particular relative pivoting movement. Preferably, the damping device is part of the connecting means, i.e. in particular it contributes to the connection.

In specific embodiments, the connecting means may comprise a first and a second connecting means. The first and second connecting means are preferably (in particular each) designed in such a way that they can (in principle) hold the portions to be connected together (at least in a non-use state in which no tensile forces are present), if necessary in such a way that the connection can only be released by exceeding a predetermined force (e.g. of at least 5 N) and/or (only) by application of a force not directed in the tensile direction and/or by destruction. If necessary, both connecting means can cooperate in such a way that they realize a sufficiently stable and secure connection of the respective portions to be connected in the state of use.

The first connecting means preferably enables the relative movement (pivoting). Alternatively or additionally, the second connecting means can limit the relative movement (in particular the relative pivoting) to a predetermined range of movement (pivoting angle). In particular, it is the case that the first connecting means alone (i.e. without taking the second connecting means into account) enables a movement (in particular pivoting) in a predetermined range (in particular pivoting range, possibly also unlimited pivoting), which predetermined range is limited by the second connecting means. In other words, if the second connecting means were omitted, the first connecting means (and the structure as a whole) would preferably allow a more extensive movement (for example, a greater angle of adjustment). For example, the angle of rotation then permitted may be 1.3 times, preferably 2 times, possibly at least 3 times, the actual angle of rotation to which the movement is limited by the second linkage.

The damping device can be assigned to (only) the first or (only) the second connecting means, or to both the first and the second connecting means. By an assignment to the (respective) connecting means it is to be understood that the damping device at least co-causes or at least co-defines the connection (or the holding together).

Preferably, the end of the first or second portion is (reversibly) detachably connectable to the traction device or child trailer. Alternatively, it is also possible that the first end of the first or second portion is not (non-destructively) detachably connected to the traction device or the child trailer.

The above-mentioned object is further solved in particular by a traction transmission device, preferably a traction bar, for transmitting a traction force of a traction device, preferably comprising a traction harness for a running person or a trailer coupling of a vehicle (or the vehicle itself, optionally including the trailer coupling) to a cargo trailer (child trailer), preferably according to the above first aspect, comprising: connecting means for connecting a first and a second portion, one of the two portions being part of the traction transmission device or the traction device, and the other of the two portions being part of the traction transmission device or the child trailer, the connecting means comprising first connecting means allowing relative pivoting of the two portions towards each other and second connecting means limiting and/or damping the relative pivoting to a predetermined range of movement.

Restriction of the relative pivoting is to be understood in particular as meaning that the pivoting is restricted to a predetermined pivoting angle range by the second connecting means, although the first connecting means would allow a larger pivoting angle range (if the second connecting means were thought away). By a damping of the relative pivoting is to be understood in particular that the second connecting means is such that a pivoting movement permitted by the first connecting means is only transmitted in a damped manner. A torque required for (relative) pivoting can, for example, be doubled by the second connecting means (or by a damping device associated therewith) in a (any) contiguous angular range (A) of, for example, at least 2° or at least 5°, compared with a case in which the second connecting means (or a corresponding associated damping device) is not provided. Here too, however, the second connecting means should preferably be basically such that it alone can hold the two portions together (although this does not necessarily correspond to a state of use).

The first connecting means preferably comprises a (bearing) axle. Alternatively or additionally, the second connecting means preferably comprises a guide device within which an engagement means is movable (whereby the movement of the engagement means is limited by the guide device).

Thus, according to a second aspect of the invention, it is particularly proposed to interconnect two portions within a system (comprising a child trailer, a traction transmission device and a traction device) via two connecting means, wherein one of the two connecting means enables a (relative) pivoting of the two connected portions, which in turn is restricted by the second connecting means. This enables a comparatively comfortable traction of the child trailer in a safe yet compact manner.

The first and/or second portion is/are preferably (at least substantially) rigid (or inherently dimensionally stable). Preferably, the first and/or second portion are (at least substantially) inelastic. This is preferably to be understood to mean that the modulus of elasticity of the material or materials (which together account for at least 90%, preferably at least 98%, optionally 100% of the weight of the respective portion) of the respective portion is at least 1 GPa, preferably at least 10 GPa, optionally at least 25 GPa.

The first and/or second portion may have a length of at least 15 cm, preferably at least 30 cm, optionally at least 35 cm and/or less than 100 cm.

The first portion may have a length which is at least 0.5 times, preferably at least 0.75 times and/or at most 2 times, preferably at most 1.5 times the length of the second portion.

First and second portion can define (in the connected state) at least 60%, preferably at least 90% of the length (possibly the complete length) of the traction transmission device (in particular traction bar). The (respective) length means in particular the maximum possible distance of a pair of points from all pairs of points of the (respective) portion or element.

The traction transmission device (traction bar) can have a length of at least 40 cm, possibly at least 65 cm, and/or a maximum of 200 cm.

The first and/or second portion can (at least predominantly) be made entirely of metal and/or plastic, in particular fiber-reinforced plastic.

First and/or second portion can form a (at least in part straight and/or in particular at least in part bent) profile (solid profile or hollow profile) or tube.

The first and second portions are preferably connected to each other in such a way that (at least in the state of use) they can be moved relative to each other exclusively via a relative pivoting movement (i.e. in particular they cannot be moved against each other via a translatory or purely translatory movement). The swivel axis can preferably be located in the connecting means (in particular in the first or the second connecting means), but according to an embodiment it can also be located outside the connecting means and possibly also outside the traction transmission device.

According to an embodiment, the first and second portions can be pivoted against each other about a particularly rigid axis (preferably at least substantially horizontal at least in the state of use). This (rigid) axis is preferably part of the first connecting means.

The damping device may comprise at least one spring device (or exactly one spring device). The spring device preferably comprises or is preferably formed by: an elastic element, the elastic element preferably being at least partially formed by an elastomer, and/or at least one coil spring and/or at least one leaf spring and/or at least one rotational spring. The elastic element (in particular when formed by an elastomer) may have a Young's modulus (at 20° C.) of less than 1 GPa, more preferably less than 0.5 GPa, still more preferably less than 0.1 GPa. If the elastic element comprises different materials, this preferably applies to at least one material, optionally to all materials, or at least to materials that in total define at least 90% of the total weight. According to an embodiment, however, the elastic element can also have a comparatively large modulus of elasticity, for example if it is a spring (e.g. steel spring).

Insofar as a modulus of elasticity is to be determined, the respective conditions preferably apply at least for one direction (for anisotropic materials). Preferably, the modulus of elasticity at 20° C. shall be used.

The connecting means, in particular the second connecting means, preferably comprises a guide device (in particular with an at least in part round or oval inner cross-section) and an engagement means movable within the guide device (in particular with an at least in part round or oval outer cross-section). As an alternative to a round or oval inner cross-section of the guide device, an elongated hole-like inner cross-section can also be present (in particular an inner cross-section that is at least in part arc-shaped and possibly describes the portion of a circle). At least one damping device, in particular comprising an elastic element (preferably at least formed by an elastomer), can be arranged at least in portions between the guide device and the engagement means (optionally around the engagement means).

Preferably, the two portions to be connected are connected to each other via the first connecting means, in particular rotatably mounted (against each other), in such a way that a rotation about an axis (preferably lateral with respect to the direction of travel and/or horizontal in the position of use) of the portions relative to each other is permitted. Rotation about a vertical axis (with respect to the direction of travel or in the use position) and/or an axis in the direction of travel (in the use position) is preferably (already) prevented by the first connecting means. Preferably, all degrees of freedom are (already) taken away from the (relative) movement of the two portions to each other by the first connecting means, except for the rotation about a lateral or horizontal axis of the portions to each other. For this purpose, one of the two portions may have a continuous axis (physically independent at least in portions). The other of the two portions, on the other hand, can have a through recess (in particular a through hole) for mounting the axle.

Preferably, the two portions are connected to each other by the second connecting means in such a way that one of the two portions has an encompassing or at least partially encompassing (defining a first recess, in particular in the lateral direction) guide device (guide element) within which (in particular within its recess) an engagement means (engagement element) of the other portion is guided (by engaging in the recess).

Preferably, a damping device is provided (at least in portions) between the guide device and the engagement means in order to dampen the (relative-) movement of the engagement means in the guide device. Alternatively or additionally, the damping device can also be assigned to the first connecting means, for example, and be designed as a rotational or torsion spring.

The range of restriction of the relative movement (pivoting or, respectively, rotational movement) is determined or, respectively, predetermined in particular by the geometry of the guide device and/or the damping properties of the damping device (the elastic element).

The guide device can be designed as a sleeve, for example.

The engagement means preferably extends continuously through the guide device (in particular its recess). An embodiment deviating from this, for example a pin, is also possible.

The damping device (in particular the elastic element) can completely or partially fill an inner space or, respectively, the recess of the guide device, in particular in a cushioning way. Alternatively or additionally, a coupling, for example via springs, is also possible.

If the elastic element is at least partially formed from an elastic material (in particular elastomer), it preferably rests at least in portions against an inner surface of the engagement means (or its recess) and/or itself has a (second) recess, the guide device further preferably extending completely or at least partially through the second recess and further preferably resting (directly) against the elastic element (or the elastic material). The second recess may also divide the elastic element (or elastic material) into two separate elements.

In general, the elastic element can consist of one (one-piece or, respectively, monolithic) body or of several (possibly separated or spaced) bodies.

If, according to the embodiment, only one degree of freedom (namely rotation) is still available through the first connecting means, a possible movement of the engagement means in the guide device is fixed. The elastic element should then preferably be arranged in the engagement means (or in its recess) in such a way that it is compressed (and/or expanded) at least in portions, in particular by this movement. If the elastic element is an elastic material, the engagement means can have a cross-section without edges (in particular a round or elliptical or oval cross-section). This is a simple way of preventing the elastic element (or its material) from being subjected to excessive mechanical stress.

According to an embodiment, the engagement means transmits the forces occurring due to the movements to the elastic element (possibly the elastic material, in particular the elastomer), whereby a damping effect is achieved. Depending on the characteristics of the elastic element (or its elastic material) and/or the shape of the elastic element, movements of different strengths can be absorbed or damped. Advantageously, the material is adjusted in such a way that no fundamental vibrations can be excited during normal use (i.e. in particular at speeds that can be expected for the type of movement of the person pulling the child trailer and taking into account the weight of the child trailer, including the load, as well as the length of the traction transmission device).

In embodiments, the first portion may be associated with the (possibly physically pronounced), in particular lateral, axis and the guide device, while the second portion, rotatably mounted around the (lateral) axis, is associated with the engagement means.

In an alternative embodiment, the first portion can be associated with the (possibly physically pronounced), in particular lateral, axis and the engagement means, while the second portion, rotatably mounted around the (lateral) axis, is associated with the guide device.

In a further embodiment, the second portion may be associated with the (possibly physically pronounced), in particular lateral, axis and the guide device, while the first portion, rotatably mounted around the (lateral) axis, is associated with the engagement means.

In yet another embodiment, the second portion may have associated with it the (possibly physically pronounced) lateral axis and the engagement means, while the first portion, rotatably mounted about the (lateral) axis, has associated with it the guide device.

Furthermore, it is also possible that the (lateral) axis is not (permanently) assigned to either of the two portions, but is an independent component. A possible design for this would be one pin or two interacting pins.

The traction transmission device, in particular the traction bar, and/or its first and/or second portion, can run straight at least in portions (possibly over the entire length).

The damping device can be arranged at different positions of the traction transmission device, but in particular in a middle portion and/or in a portion of the strongest curvature of the traction transmission device.

The traction transmission device, in particular the traction bar, and/or its first and/or second portion, can be curved at least in portions (possibly over the entire respective length).

The damping device can be adjustable and/or deactivatable with regard to its damping characteristics. For example, a spring hardness of the damping device can be varied or a suspension can be bypassed (and thus deactivated). Alternatively or additionally, the damping device is at least partially replaceable. In particular, when walking or skiing, the damping element may be undesirable due to different movement patterns than, for example, when running. For example in such a case, it may then be advantageous to deactivate the damping device. This can be done, for example, by bridging one of the two connecting means (e.g. with a rigid element) so that rotation is prevented.

It is possible to adapt the damping device to the needs of the person pulling, for example, by replacing it (in particular the respective elastic element) with one with different characteristics. This also enables replacement in the event of a defect or wear.

The traction transmission device (traction bar) is preferably collapsible. Specifically, the traction transmission device (traction bar) can be provided in such a way that it is rotatably mounted in the area of at least one connecting means (in particular the first and/or second connecting means) in such a way that it can be folded up in order to compress it in its length. This can be useful, for example, for transport or stowage.

In the state of use, the first and/or second portion can be pivoted against each other by preferably a maximum of 45°, further preferably a maximum of 25°, and/or at least 2°, preferably at least 5°. This applies, if applicable, to any state of the traction transmission device (traction bar) provided that it is intact (i.e. not destroyed). If necessary, however, it is also possible to allow further pivoting (e.g. beyond 45°) in a state of non-use (e.g. storage state).

The above-mentioned object is further solved by a system comprising a traction transmission device, in particular a traction bar, as explained above, as well as i) a traction harness and/or a vehicle or at least its trailer coupling, wherein the traction harness or the vehicle or at least its trailer coupling can be releasably or non-releasably connected to the traction transmission device and/or ii) a child trailer, wherein the child trailer being connectable or connected to the traction transmission device in a releasable or non-releasable, preferably relatively movable (in particular relatively pivotable), manner.

In particular, the traction transmission device can be connected (possibly fixed) at one end to a traction harness. Alternatively or additionally, the traction transmission device can have a connection element for connecting the traction transmission device to a traction harness or another element that enables a pulling person to transmit force to the traction transmission device.

At one (further) end, the traction transmission device can be (possibly firmly) connected to another element, such as a cabin or an axle of the child trailer. Alternatively or additionally, the traction transmission device can have a coupling element for coupling with another element of the child trailer.

The child trailer preferably has at least one ground contact element, for example two (possibly exactly two) ground contact elements. Preferably, the at least one ground contact element is a wheel. Alternatively, however, a skid (or a ski) is also possible.

The child trailer may be configured as a rickshaw. The child trailer can be configured so that it can be pulled by human power, in particular by running, walking and/or by a vehicle, in particular a bicycle.

The child trailer can have a weight of less than 50 kg and/or more than 5 kg.

The above object is further solved by a method for preparing (or manufacturing) the above system, wherein in case i) the traction harness or the vehicle or at least its trailer coupling is detachably or non-detachably, preferably relatively movable, connected to the traction transmission device and/or in case ii) the child trailer is detachably or non-detachably, preferably relatively movable, connected to the traction transmission device. Further embodiments of the method result from the above and/or following description of the traction transmission device, whereby purpose specifications and/or functional features can be carried out as specific method steps.

Further embodiments result from the subclaims.

In the following, the invention is described by means of examples, which are explained in more detail with reference to the figures. Hereby show:

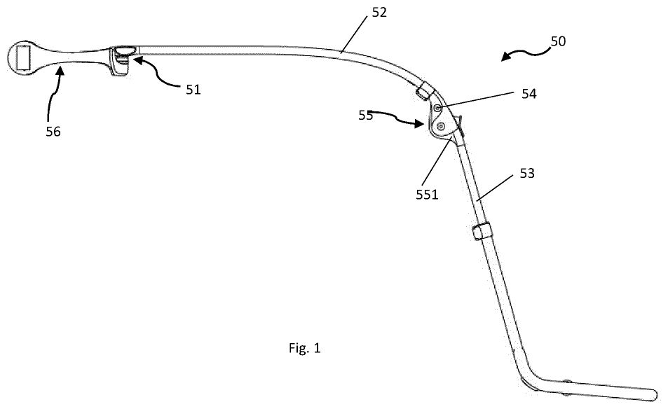

FIG. 1a side view of a traction transmission device according to the invention;

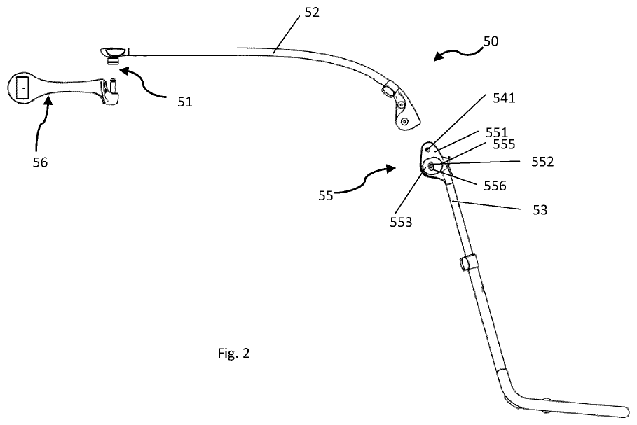

FIG. 2 the traction transmission device according to FIG. 1 in a partially dismantled state;

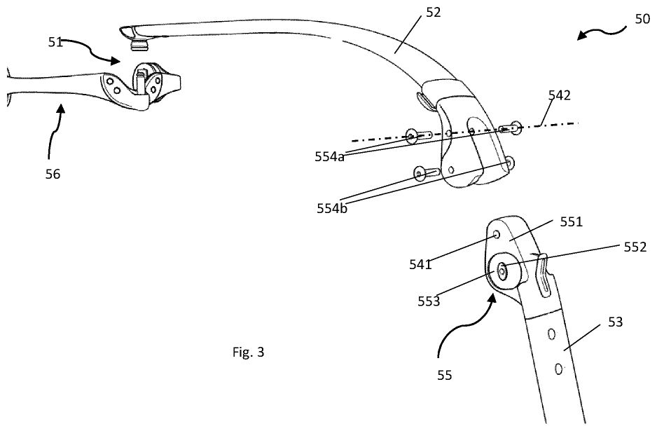

FIG. 3 the traction transmission device according to FIG. 1, exploded view in portions;

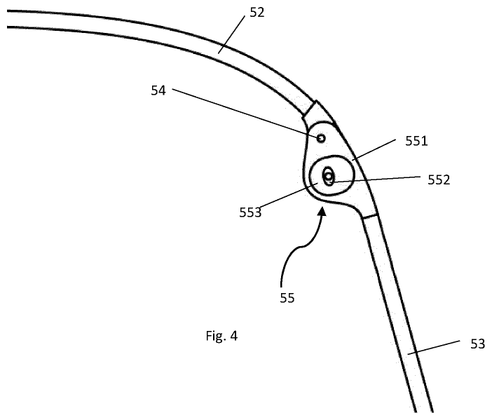

FIG. 4 a side view of a portion of the traction transmission device according to FIG. 1;

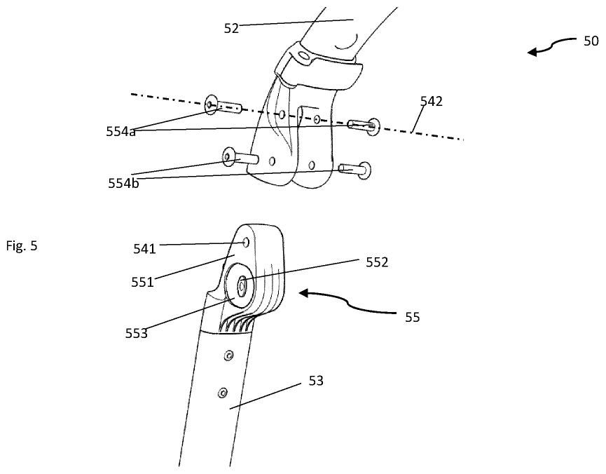

FIG. 5 an exploded view of a portion according to FIG. 3;

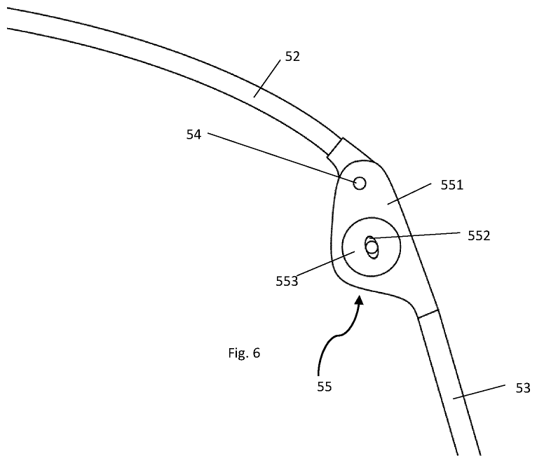

FIG. 6 a side view of a train transmission device;

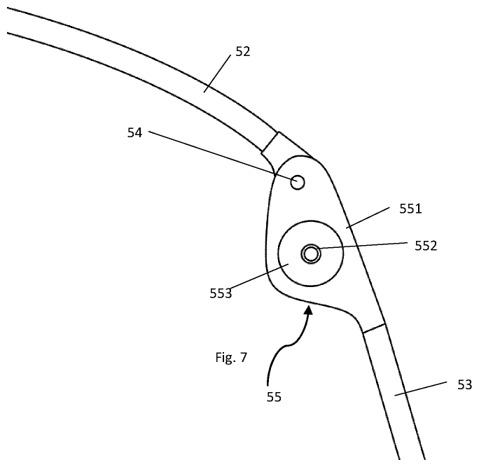

FIG. 7 a representation analogous to FIG. 6 of a further embodiment of the traction transmission device;

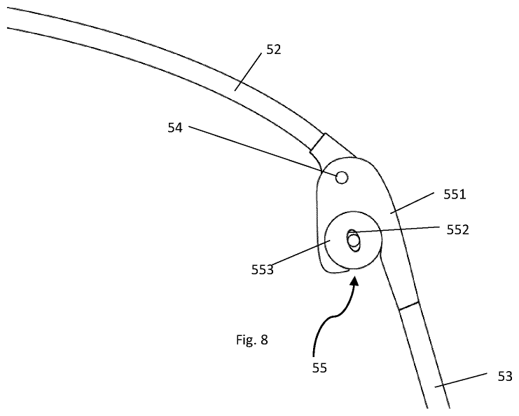

FIG. 8 a representation analogous to FIG. 6 of a further embodiment of the traction transmission device;

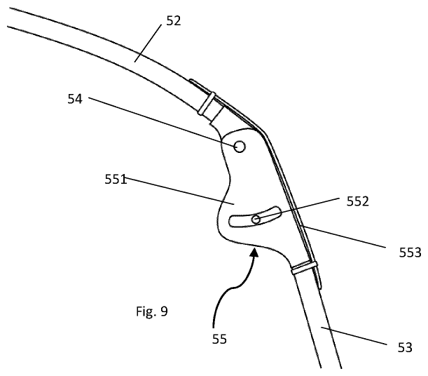

FIG. 9 a representation analogous to FIG. 6 of a further embodiment of the traction transmission device;

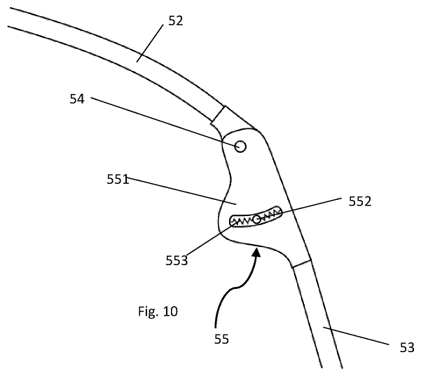

FIG. 10 a representation analogous to FIG. 6 of a further embodiment of the traction transmission device;

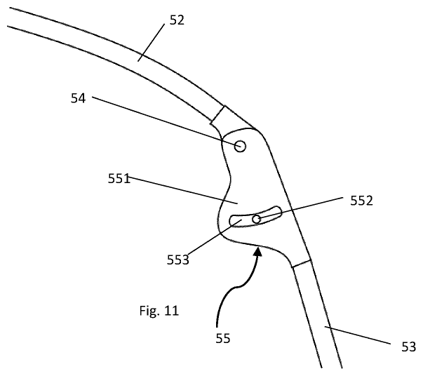

FIG. 11 a representation analogous to FIG. 6 of a further embodiment of the traction transmission device; and

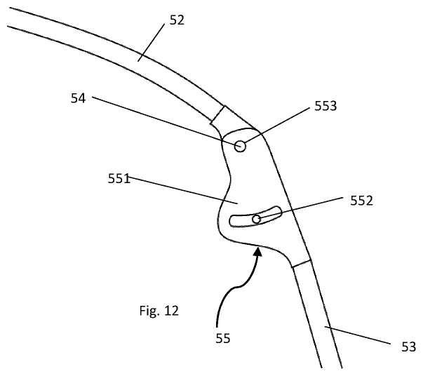

FIG. 12 a representation analogous to FIG. 6 of a further embodiment of the traction transmission device.

In the following description, the same reference numbers are used for identical and equally acting parts.

FIG. 1 shows a side view of a traction transmission device (traction bar) 50 according to the invention. The traction transmission device 50 has a first portion 52 with a first and second end and a second portion 53 with a first and second end. The two portions 52, 53 are connected to each other at their (respective) second end via a first connecting means 54 and a second connecting means 55. The first portion 52 is further connected at its second end to a (traction) harness 56 via a tethering element or tethering device 51. The second end of the second portion 53 can be connected to a child trailer (not shown).

The second connecting means 55 has a guide device 551.

According to FIG. 2, the first connecting means 54 comprises a through hole 541. The guide device 551 of the second connecting means 55 comprises a first recess 555. In the first recess 555 there is a damping device 553 and an engagement means 552 engaging in a second recess 556 of the damping device 553.

As can be seen in FIG. 3, the second connecting means 55 comprises the guide device 551 and an elastic element 553 located in the first recess 555, as well as an engagement means 552 (which is indirectly guided inside the guide device 551 (serving as an abutment) so that the elastic element yields) engaging (directly) in the elastic element 553. The first connecting means 54 has a through hole 541. Pins 554a, 554b fix the first portion 52 and the second portion 53 in the region of the first connecting means 54 and the second connecting means 55. The pins 554a form a (lateral, with respect to the state of use) axis 542 with the through hole 541, while pins 554b connect to the engagement means and thereby to the elastic member 543. If vibrations occur during use, the first and second portions 52, 53 rotate on the (lateral) axis 542, while the engagement means 552 transmits the rotational movements to the elastic member 553 via the pins 554b, thereby achieving damping.

FIG. 6 shows a connecting means 55 analogous to FIG. 4 with an elastic element 553, which is designed in its geometry as a round cylinder, and with an engagement means 552, which is designed in its geometry as an oval cylinder.

FIG. 7 shows a connecting means 55 analogous to FIG. 4 with an engagement means 552, the geometry of which is designed as a round cylinder.

FIG. 8 shows a second connecting means 55 analogous to FIG. 4 with a guide device 551 with a recess which does not completely enclose the elastic element 553 (but does enclose a large part of its circumference).

FIG. 9 shows a first connecting means 54 and a second connecting means 55 analogous to FIG. 4 with an elastic element 553, which is designed as a leaf spring. The guide device 551 has a (slot-like) recess which restricts the pivoting to a certain range.

FIG. 10 shows a first connecting means 54 and a second connecting means 55 analogous to FIG. 4 with an elastic element 553, which is designed as or comprises a (conventional) compression spring. Here, two springs can be provided on the engagement means 552. The guide device 551 has a (slot-like) recess which restricts the damping to a certain area.

FIG. 11 shows a first connecting means 54 and a second connecting means 55 analogous to FIG. 4 with an elastic element 553. The guide device 551 has a (slot-like) recess which restricts the damping to a certain area. The elastic element 553 (e.g. an elastomer) is provided in the (slot-like) recess.

FIG. 12 shows a first connecting means 54 with an elastic element 553 and a second connecting means 55 analogous to FIG. 4. The elastic element 553 is attached here to the first connecting means 54 and can be designed, for example, as a torsion or torsion spring. The guide device 551 has a (slot-like) recess which restricts the damping to a certain area.

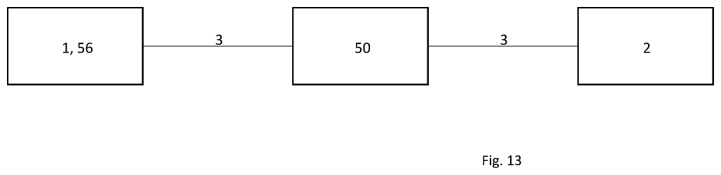

FIG. 13 schematically shows a traction device 1 or an element of a traction device (e.g. a traction harness 56 or a trailer coupling) connected via a connection 3 to a traction transmission device 50, which in turn is connected (also via a connection 3) to a child trailer 2.

At this point, it should be noted that all the parts described above, taken individually and in any combination, in particular the details shown in the drawings, are claimed to be essential to the invention. Modifications hereof are familiar to the skilled person.

### REFERENCE SIGN

1 Traction device
2 Child trailer
3 Connection
50 Train transmission device
51 Tethering element
52 First Portion
53 Second portion
54 First connecting means
55 Second connecting means
56 (Traction) harness
541 Through hole
542 (lateral) axis
551 Guide device
552 Engagement means
553 Damping device
554a Pin
554b Pin
555 first recess
556 second recess

1. A traction transmission device, in particular a traction bar, for transmitting a traction force of a traction device, comprising a traction harness for a running person or a trailer coupling of a vehicle to a child trailer, comprising:
a first portion having a first end and a second end,
a second portion having a first end and a second end,
wherein one of the first ends is connected or connectable to the child trailer and another of the first ends is connected or connectable to the traction device,
wherein the second ends are connected via a connecting means, in such a way that a relative movement, in particular a relative pivoting movement, is enabled between the second ends in a state of use of the traction transmission device.

2. The traction transmission device, in particular traction bar, according to claim 1,
wherein
a damping device is assigned to the connecting means in order to damp the relative movement.

3. The traction transmission device, in particular traction bar, according to claim 1,
wherein
the connecting means comprises a first connecting joint which enables relative movement, and/or a second connecting joint, which limits the relative movement to a predetermined range of movement, wherein the damping device is associated with the first or the second connecting joint or both the first and the second connecting joint.

4. The traction transmission device, in particular traction bar, according to claim 1,
wherein
first end of the first or second portion is detachably connected or connectable to the traction device or the child trailer.

5. A traction transmission device, in particular a traction bar, for transmitting a traction force of a traction device, in particular comprising a traction harness for a running person or a trailer coupling of a vehicle to a child trailer, according to claim 1, comprising:
connecting joint for connecting first and second portions, one of the two portions being part of the traction transmission device or the traction device, and the other of the two portions being part of the traction transmission device or the child trailer, wherein said connecting joint comprises first connecting joint allowing relative pivoting of said two portions with respect to each other and second connecting joint limiting and/or damping said relative pivoting to a predetermined range of movement.

6. The traction transmission device, in particular traction bar, according to claim 1,
wherein
the first or the second portion is designed to be at least substantially rigid and has a length of at least 15 cm,
the first portion has a length which is at least 0.5 times and at most 2 times as great as the length of the second portion and/or
first and second portions define at least 60%, of the length of the traction transmission device, in particular traction bar, in a state connected by the connecting joint.

7. The traction transmission device, in particular traction bar, according to claim 1,
wherein
first and second portions are connected to one another in such a way that, in a state of use, they can be moved relative to one another exclusively by means of a relative pivoting movement.

8. The traction transmission device, in particular traction bar, according to claim 1,
wherein
first and second portions are pivotable relative to one another about a rigid axis at least substantially horizontal in a state of use.

9. The traction transmission device, in particular traction bar, according to claim 2,
wherein
the damping device comprises at least one spring device comprising or formed by: an elastic element, the elastic element including at least partially of an elastomer, and/or at least one helical spring and/or at least one leaf spring and/or at least one rotational spring.

10. The traction transmission device, in particular traction bar, according to claim 5,
wherein
the connecting joint, in particular the second connecting joint, has a guide device, in particular with an inner cross-portion which is round, oval and/or arcuate at least in portions, and an engagement means which is movable within the guide device, in particular with an outer cross-portion which is round or oval at least in portions, wherein at least one damping device, in particular comprising an elastic element, is arranged at least in portions between the guide device and the engagement means.

11. The traction transmission device, in particular traction bar, according to claim 1,
wherein
the traction transmission device, in particular the traction bar, and/or its first and/or second portion runs/run straight, at least in portions.

12. The traction transmission device, in particular traction bar, according to claim 1,
wherein
the traction transmission device, in particular the traction bar, and/or its first and/or second portion runs/run in a curved manner at least in portions.

13. The traction transmission device, in particular traction bar, according to claim 1,
wherein
the damping device is adjustable and/or deactivatable with regard to its damping properties or is partially replaceable.

14. The traction transmission device, in particular traction bar, according to claim 1,
wherein
it is foldable, preferably in the region of the connecting means.

15. The traction transmission device, in particular traction bar, according to claim 1,
wherein
first or second portions can be pivoted, in a state of use, relative to one another by a maximum of 45°.

16. A system comprising a traction transmission device, in particular a traction bar, according to claim 1 and
i) a traction harness and/or a vehicle or at least its trailer coupling, wherein the traction harness or the vehicle or, respectively, its trailer coupling can be releasably or non-releasably connected to the traction transmission device, or
ii) a child trailer, wherein the child trailer is releasably or non-releasably connected to the traction transmission device.

17. A method of preparing a system according to claim 16, wherein in case i) the traction harness or the vehicle or its trailer coupling is releasably or non-releasably connected to the traction transmission device and/or in case ii) the child trailer is releasably or non-releasably connected to the traction transmission device.
